(19) United States
(12) Patent Application Publication
(10) Pub. No.: US 2016/0243594 A1
(43) Pub. Date: Aug. 25, 2016

(54) Discharge Method and Device of Washing Chamber

(71) Applicant: SHENZHEN CHINA STAR OPTOELECTRONICS TECHNOLOGY CO., LTD., Guangdong (CN)

(72) Inventor: Jia LI, Shenzhen, Guangdong (CN)

(73) Assignee: Shenzhen China Star Optoelectronics Technology Co., Ltd., Shenzhen, Guangdong (CN)

(21) Appl. No.: 14/378,404

(22) PCT Filed: Jul. 2, 2014
(86) PCT No.: PCT/CN2014/081441

§ 371 Date: Aug. 13, 2014

(30) Foreign Application Priority Data
Jun. 4, 2014 (CN) 201410245704.5

(51) Int. Cl. B08B 3/08; B08B 13/00

(52) U.S. Cl. CPC B08B 3/08; B08B 13/00

(57) ABSTRACT

The invention discloses a discharge method and device of a washing chamber. The method includes the following steps. Step 1: provide a washing chamber. Step 2: set a wastewater discharge pipe and a waste liquid discharge pipe both connected to the washing chamber, and each of the wastewater discharge pipe and the waste liquid discharge pipe communicates with the washing chamber by a valve. Step 3: set a detector in the washing chamber to detect the concentration of a predetermined ingredient in the washing chamber. Step 4: open one of the two valves to make the washing chamber communicate with the wastewater discharge pipe or the waste liquid discharge pipe according to the detecting result of the detector so as to drain the liquid in the washing chamber. The invention achieves the purpose of recycling and classification of the wastewater and the waste liquid according to the variety of the concentration of a harmful substance included in the liquid in the washing chamber. Thus, the discharging amount of the waste liquid and the cost in cleaning the waste liquid are both reduced significantly. That saves the manufacturing cost and improves product competitiveness.

### BACKGROUND OF THE INVENTION

1. Field of the Invention

The present invention relates to the manufacture field of liquid crystal display (LCD), and more particularly, to a discharge method and device of a washing chamber.

2. Description of Related Art

A flat-panel display device has many advantages of a thin body, low power consumption, no radiation, etc. and is used worldwide. The sort of the conventional flat-panel display mainly includes a liquid crystal display (LCD) and an organic light emitting display (OLED).

The conventional LCD usually belongs to a backlight type, including a case, a LCD panel in the case, and a backlight module in the case. The working principle of the LCD panel is that liquid crystal molecules are placed between parallel two glass substrates, and a driving voltage is applied to the two glass substrates to control the rotation of the liquid crystal molecules, so that the light from the backlight module is refracted to produce the image.

The LCD panel usually has a color filter (CF) substrate, a thin film transistor (TFT) substrate, liquid crystal (LC) material between CF substrate and TFT substrate, and a sealant. The manufacture method of the LCD panel generally includes a front array process (thin film, photo, etching, and stripper), a middle cell process (bonding the CF substrate and TFT substrate), and a rear module assembly process (laminating driving circuits and a printed circuit board).

In the front array process of the liquid crystal display panel, many steps require the use of a wet liquid. After completion of the liquid-treatment process, a washing process is generally necessary, so as to wash away the residual liquid. Since the discharge device of the conventional washing chamber is unable to distinguish between the wastewater including low concentration of a harmful substance and the waste liquid including high concentration of a harmful substance for draining classifiably, the amount of waste liquid becomes very large. Because the waste liquid is necessary to be cleaned by a processing station, that causes a high cost. Relatively, because the wastewater can be discharged to the wastewater processing station of the company generating it to be cleaned, the cost saves. Therefore, the more the waste liquid is discharged, the more money is.

Please refer to FIG. 1, FIG. 1 is a schematic diagram of a discharge device of a conventional washing chamber, including the washing chamber 2 and the discharge pipe 4. The liquid in the washing chamber 2 is directly drained in operation. The way makes the amount of the waste liquid large and the cost in cleaning the waste liquid high. Thus, it is an urgent research topic to reduce the discharging amount of the waste liquid so as to save the cost.

### SUMMARY OF THE INVENTION

An object of the invention is to provide a discharge method of a washing chamber. The discharge method achieves the purpose of recycling and classification of the wastewater and the waste liquid according to the variety of the concentration of a harmful substance included in the liquid in the washing chamber. Thus, the discharging amount of the waste liquid and the cost in cleaning the waste liquid are both reduced significantly.

Another object of the invention is to provide a discharge device of a washing chamber. A detector is assembled to a drain outlet of the washing chamber and connected electrically to a control unit. The control unit controls the valve set on a wastewater discharge pipe or the valve set on a waste liquid discharge pipe to be opened according to the variety of the concentration of a harmful substance detected by the detector. The discharge device achieves the purpose of recycling and classification of the wastewater and the waste liquid. Thus, the discharging amount of the waste liquid and the cost in cleaning the waste liquid are both reduced significantly

To achieve the above objects, the present invention provides a discharge method of a washing chamber, including the following steps.

Step 1: provide a washing chamber.

Step 2: set a wastewater discharge pipe and a waste liquid discharge pipe both connected to the washing chamber. Each of the wastewater discharge pipe and the waste liquid discharge pipe communicates with the washing chamber by a valve.

Step 3: set a detector in the washing chamber. The detector is used to detect the concentration of a predetermined ingredient in the washing chamber.

Step 4: open one of the two valves to make the washing chamber communicate with the wastewater discharge pipe or the waste liquid discharge pipe according to the detecting result of the detector so as to drain the liquid in the washing chamber.

The washing chamber 21 is used in the wet process of a TFT-LCD.

The valves are automatic valves.

The detector is connected to a control unit. The control unit is electrically connected to the two valves. The detector transmits the detecting result to the control unit. The control unit decides to open the valve set on the wastewater discharge pipe or the valve set on the waste liquid discharge pipe according to the detecting result.

The washing chamber has a drain outlet. Each of the wastewater discharge pipe and the waste liquid discharge pipe is connected to the drain outlet through the valve. The detector is assembled to the drain outlet.

Step 5: when the concentration of the predetermined ingredient is equal to or greater than a predetermined value, open the valve set on the waste liquid discharge pipe to make the washing chamber communicate with the waste liquid discharge pipe; when the concentration of the predetermined ingredient is lower than the predetermined value, open the valve set on the wastewater discharge pipe to make the washing chamber communicate with the wastewater discharge pipe.

The invention also discloses a discharge device of a washing chamber, including a washing chamber, a wastewater discharge pipe and a waste liquid discharge pipe respectively connected to the washing chamber, a detector, and a control unit. Each of the wastewater discharge pipe and the waste liquid discharge pipe communicates with the washing chamber by a valve. The valves are automatic valves. The detector is electrically connected to the control unit. The valves are electrically connected to the control unit respectively.

The washing chamber is used in the wet process of a TFT-LCD.

The washing chamber has a drain outlet. Each of the wastewater discharge pipe and the waste liquid discharge pipe is connected to the drain outlet through the valve.

The detector is assembled to the drain outlet.

In conclusion, the invention discloses a discharge method and device of a washing chamber. By setting the wastewater discharge pipe and the waste liquid discharge pipe both connected to the washing chamber, each of the wastewater discharge pipe and the waste liquid discharge pipe communicates with the washing chamber by a valve. A detector is set in the washing chamber, and used to detect the concentration of a predetermined ingredient in the washing chamber. One of the two valves is opened to make the washing chamber communicate with the wastewater discharge pipe or the waste liquid discharge pipe according to the detecting result of the detector, so as to drain the liquid in the washing chamber. The invention achieves the purpose of recycling and classification of the wastewater and the waste liquid according to the variety of the concentration of a harmful substance included in the liquid in the washing chamber. Thus, the discharging amount of the waste liquid and the cost in cleaning the waste liquid are both reduced significantly. That saves the manufacturing cost and improves product competitiveness.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a discharge device of a conventional washing chamber.

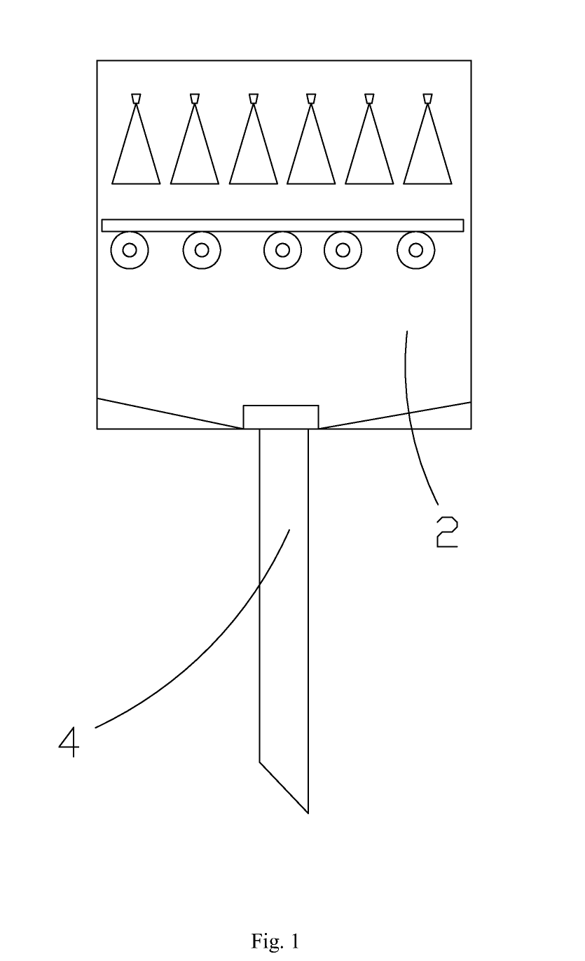

FIG. 2 is a flow chart of a discharge method of a washing chamber according to the present invention.

FIG. 3 is a schematic diagram of a discharge device of a washing chamber according to the present invention.

FIG. 4 is a schematic diagram of a control system of a discharge device of a washing chamber according to the present invention.

### DESCRIPTION OF THE EMBODIMENTS

Following exemplary embodiments with reference of figures are only used for describing the disclosure in detail. However, the disclosure can also be achieved through different implementations, which is not limited to the following embodiments. In the figures referred to herein, sizes and relative sizes of different layers are probably exaggerated for clarity of illustration and are not necessarily drawn to scale.

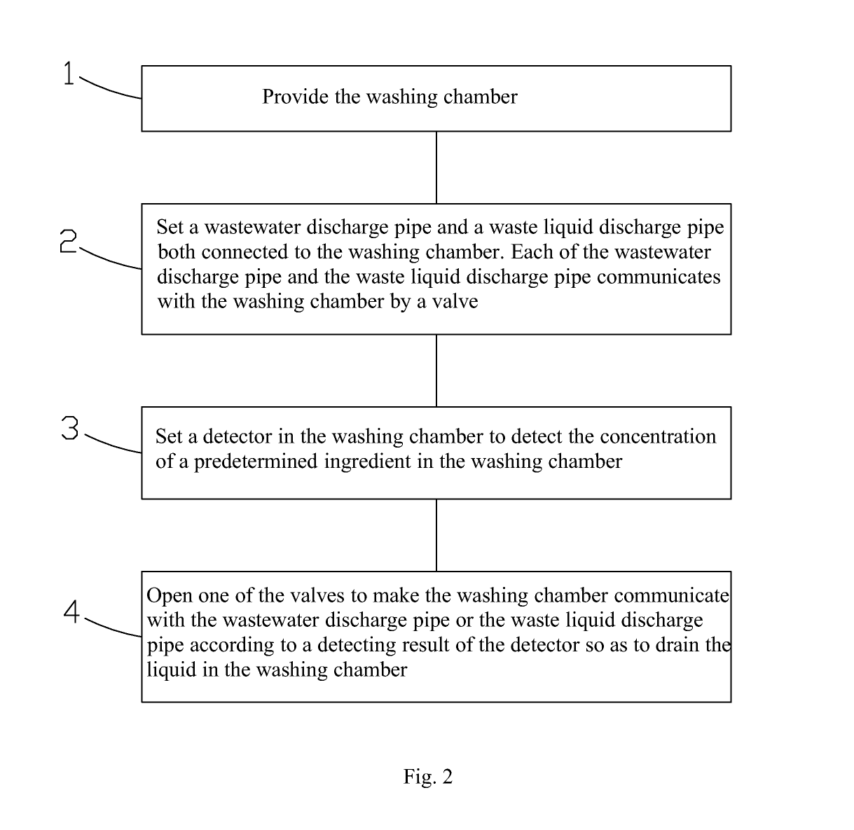

Please refer to FIG. 2, the present invention provides a discharge method of a washing chamber, including the following steps:

Step 1: provide a washing chamber.

The washing chamber is used in the wet process of a thin film transistor liquid crystal display (TFT-LCD).

Step 2: set a wastewater discharge pipe and a waste liquid discharge pipe both connected to the washing chamber.

Each of the wastewater discharge pipe and the waste liquid discharge pipe communicates with the washing chamber by a valve. The valves are automatic valves, for example.

The washing chamber has a drain outlet. Each of the wastewater discharge pipe and the waste liquid discharge pipe is connected to the drain outlet through the valve.

Step 3: set a detector in the washing chamber. The detector is used to detect the concentration of a predetermined ingredient in the washing chamber.

The detector is assembled to the drain outlet and connected to a control unit. The control unit is electrically connected to the two valves. The detector transmits the detecting result to the control unit. The control unit decides to open the valve set on the wastewater discharge pipe or the valve set on the waste liquid discharge pipe according to the detecting result.

Step 4: open one of the two valves to make the washing chamber communicate with the wastewater discharge pipe or the waste liquid discharge pipe according to the detecting result of the detector so as to drain the liquid in the washing chamber.

When the concentration of the predetermined ingredient is equal to or greater than a predetermined value, open the valve set on the waste liquid discharge pipe to make the washing chamber communicate with the waste liquid discharge pipe. When the concentration of the predetermined ingredient is lower than the predetermined value, open the valve set on the wastewater discharge pipe to make the washing chamber communicate with the wastewater discharge pipe.

For example, the predetermined ingredient is of fluoride ion, and the detector is a fluoride ion detector. When the concentration of the fluoride ion greater than 15 ppm, open the valve set on the waste liquid discharge pipe to make the washing chamber communicate with the waste liquid discharge pipe. The liquid in the washing chamber is drained from the washing chamber as the waste liquid, and then transferred to the processing station to be cleaned.

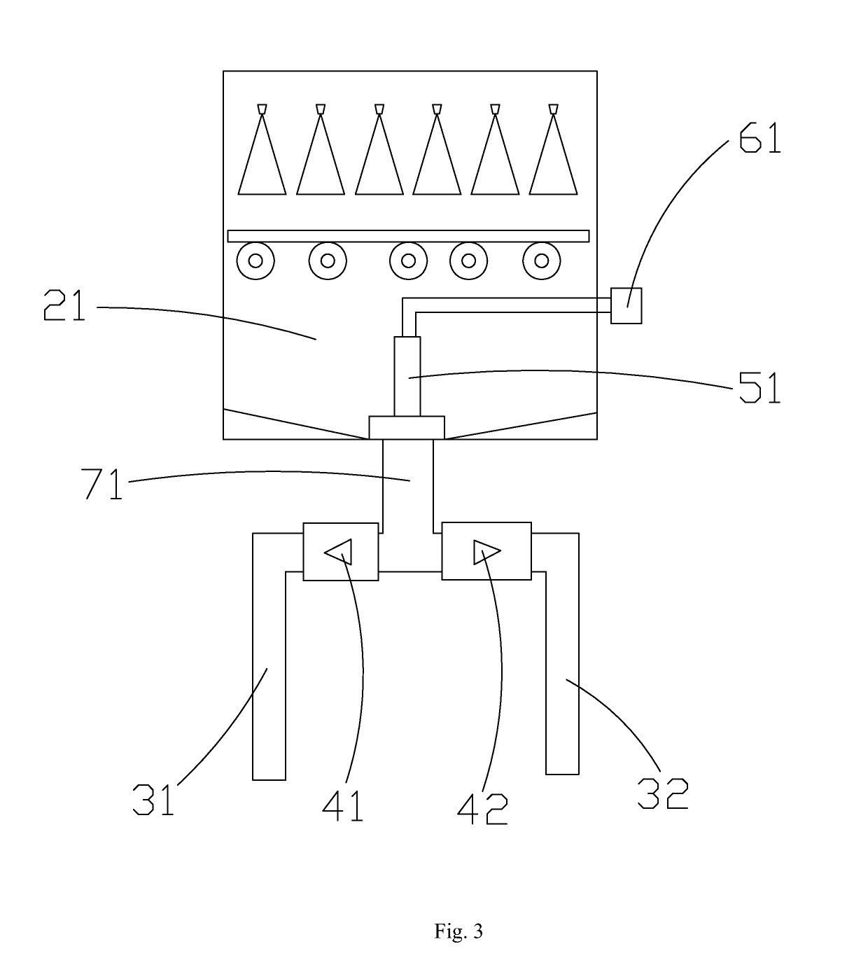

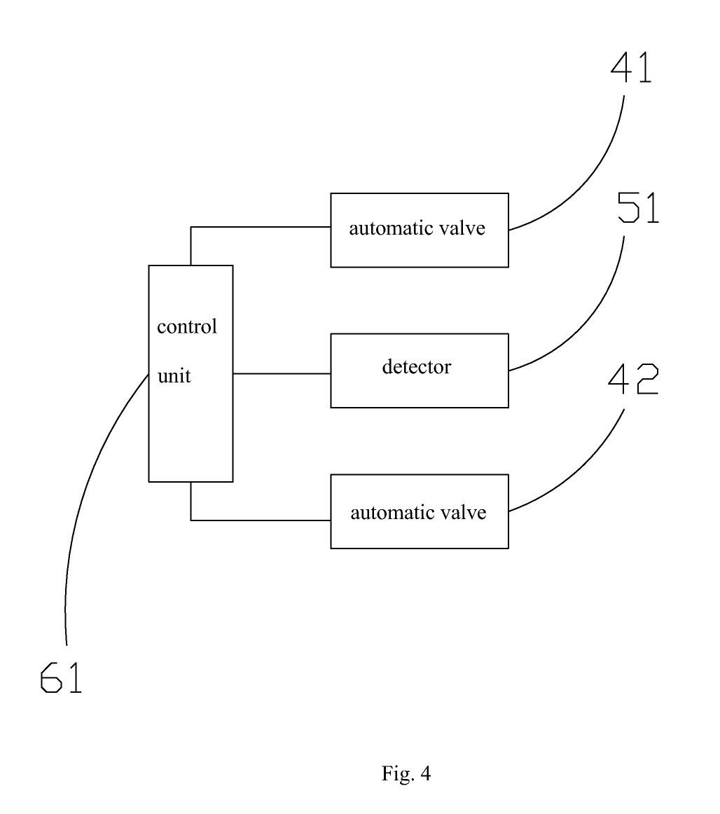

Please refer to FIGS. 3 and 4, the invention also discloses a discharge device of a washing chamber, including a washing chamber 21, a wastewater discharge pipe 31 and a waste liquid discharge pipe 32 respectively connected to the washing chamber 21, a detector 51, and a control unit 61. Each of the wastewater discharge pipe 31 and the waste liquid discharge pipe 32 communicates with the washing chamber 21 by a valve (41 or 42). The valves 41, 42 are automatic valves, for example. The detector 51 is electrically connected to the control unit 61. The valves 41, 42 are electrically connected to the control unit 61 respectively. The washing chamber 21 is used in the wet process of a TFT-LCD.

The washing chamber 21 has a drain outlet 71. Each of the wastewater discharge pipe 31 and the waste liquid discharge pipe 32 is connected to the drain outlet 71 through the valve (41 or 42).

The detector 51 is assembled to the drain outlet 71. The detector 51 is used to detect the concentration of a predetermined ingredient in the washing chamber 21.

In conclusion, the invention discloses a discharge method and device of a washing chamber. By setting the wastewater discharge pipe and the waste liquid discharge pipe both connected to the washing chamber, each of the wastewater discharge pipe and the waste liquid discharge pipe communicates with the washing chamber by a valve. A detector is set in the washing chamber, and used to detect the concentration of a predetermined ingredient in the washing chamber. One of the two valves is opened to make the washing chamber communicate with the wastewater discharge pipe or the waste liquid discharge pipe according to the detecting result of the detector, so as to drain the liquid in the washing chamber. The invention achieves the purpose of recycling and classification of the wastewater and the waste liquid according to the variety of the concentration of a harmful substance included in the liquid in the washing chamber. Thus, the discharging amount of the waste liquid and the cost in cleaning the waste liquid are both reduced significantly. That saves the manufacturing cost and improves product competitiveness.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A discharge method of a washing chamber, comprising:
providing the washing chamber;
setting a wastewater discharge pipe and a waste liquid discharge pipe both connected to the washing chamber, wherein each of the wastewater discharge pipe and the waste liquid discharge pipe communicates with the washing chamber by a valve;
setting a detector in the washing chamber to detect the concentration of a predetermined ingredient in the washing chamber; and
opening one of the valves to make the washing chamber communicate with the wastewater discharge pipe or the waste liquid discharge pipe according to a detecting result of the detector so as to drain the liquid in the washing chamber.

2. The discharge method of claim 1, wherein the washing chamber is used in a wet process of a thin film transistor liquid crystal display.

3. The discharge method of claim 1, wherein the valves are automatic valves.

4. The discharge method of claim 3, wherein the detector is connected to a control unit, the control unit is electrically connected to the valves, the detector transmits the detecting result to the control unit, and the control unit decides to open the valve set on the wastewater discharge pipe or the valve set on the waste liquid discharge pipe according to the detecting result.

5. The discharge method of claim 1, wherein the washing chamber has a drain outlet, each of the wastewater discharge pipe and the waste liquid discharge pipe is connected to the drain outlet through the valve, and the detector is assembled to the drain outlet.

6. The discharge method of claim 1, further comprising:
when the concentration of the predetermined ingredient is equal to or greater than a predetermined value, opening the valve set on the waste liquid discharge pipe to make the washing chamber communicate with the waste liquid discharge pipe; and
when the concentration of the predetermined ingredient is lower than the predetermined value, opening the valve set on the wastewater discharge pipe to make the washing chamber communicate with the wastewater discharge pipe.

7. A discharge device of a washing chamber, comprising a wastewater discharge pipe and a waste liquid discharge pipe respectively connected to the washing chamber, a detector, and a control unit, wherein each of the wastewater discharge pipe and the waste liquid discharge pipe communicates with the washing chamber by a valve, the valves are automatic valves, the detector is electrically connected to the control unit, and the valves are electrically connected to the control unit respectively.

8. The discharge device of claim 1, wherein the washing chamber is used in a wet process of a thin film transistor liquid crystal display.

9. The discharge device of claim 7, wherein the washing chamber has a drain outlet, and each of the wastewater discharge pipe and the waste liquid discharge pipe is connected to the drain outlet through the valve.

10. The discharge device of claim 9, wherein the detector is assembled to the drain outlet.

11. A discharge device of a washing chamber, comprising a wastewater discharge pipe and a waste liquid discharge pipe respectively connected to the washing chamber, a detector, and a control unit,
wherein each of the wastewater discharge pipe and the waste liquid discharge pipe communicates with the washing chamber by a valve, the valves are automatic valves, the detector is electrically connected to the control unit, and the valves are electrically connected to the control unit respectively,
wherein the washing chamber is used in a wet process of a thin film transistor liquid crystal display,
wherein the washing chamber has a drain outlet, and each of the wastewater discharge pipe and the waste liquid discharge pipe is connected to the drain outlet through the valve,
wherein the detector is assembled to the drain outlet.
